(19) United States
(12) Patent Application Publication
(10) Pub. No.: US 2002/0010800 A1
(43) Pub. Date: Jan. 24, 2002

(54) Network access control system and method

(76) Inventors: Richard T. Riley, Costa Mesa, CA (US); Tienus Leslie Hoekstra, Vernon (CA)

Correspondence Address: Michael A. Kerr, Virtual Legal, P.O. Box 2345, Stateline, NV, 89449, US

(21) Appl. No.: 09/860,410

(22) Filed: May 17, 2001

Related U.S. Application Data
(63) Continuation-in-part of application No. 60/205,630, filed on May 18, 2000.

(51) Int. Cl. G06F 15/16

(52) U.S. Cl. 709/249; 713/201; 709/229

(57) ABSTRACT

The invention is a software upgradable network access control system which is preferably resident within a host computer. Preferably, the network access control card is operatively coupled to an expansion card resident within the host computer. In operation, the network access control system controls the flow of data packets to and from a host computer to a network. The host computer may be networked to a network device located on a trusted private network or on an untrusted network. The network access control system includes a dedicated processor, support memory, a first network connection and a second network connection. Preferably, a housing is provided for the network access control system so that it is received by an expansion slot within the host computer. The memory stores an operating system and a set of rules which controls a plurality of data packets which are communicated to and from the network access control system. The data packets communicated to and from the network access control system are controlled by accepting, denying or rejecting data packets. The processor compares received data packets with the set of rules which accept, deny or reject data packets. The first network connection within the housing is configured to enable communications from the processor to the host computer. The second network connection enables communications with a networked device operating in the trusted private network or the untrusted network. Each network access control system may be configured with a different set of rules.

### CROSS REFERENCES TO RELATED APPLICATIONS

This patent application is a continuation in part of a provisional patent application filed on May 18, 2000 having patent application No. 60/205,630.

### BACKGROUND OF THE INVENTION

1. Field of Invention

The present invention relates to a network access control system and method which prevents unauthorized access to a networked device. More particularly, the invention comprises a hardware system having a separate processor and a support memory which controls communications to or from the networked device.

2. Description of Prior Art

The ability to connect a first computer to a second computer through a network provides substantial benefits and generates security concerns. For individuals at home, wandering around the Internet is liberating, however, for corporate security managers users surfing the Web can create a nightmare. Most companies have large amounts of confidential information such as trade secrets, product development plans, marketing strategies, financial analyses, etc. which the need to protect. Disclosure of this information to a competitor could have dire consequences. Additionally, home users have to worry about sensitive information such as personal credit card information being accessible to third parties.

In addition to the danger of information leaking out, there is also a danger of information leaking in. In particular viruses, worms, trojan horses and other digital pests can breach security, destroy valuable data, and waste large amounts of system administrator's time. For a home user these digital pests can erase data which has not been properly backed up. Often these digital pests are imported by careless user activities.

Consequently, systems and method are needed to keep corporate networks secure and to protect home users. One method is to use encryption to protect data in transit. However, encryption does not help to keep digital pests and hackers out. Traditionally, to prevent unauthorized access to a network a firewall is needed.

Firewalls

A firewall provides a system and method for managing the information transfer between a trusted network and an untrusted network. Fundamentally, there are two “genus” of firewalls, i.e. software firewalls and hardware firewalls. Software firewalls are installed on a computer much like a word processing program and share CPU resources and memory resources with other computer programs. Software firewalls generally operate on the same operating system that is used to manage the applications of the host computer. Software firewalls are affordable but can create security breaches because of well-known “hacks” to the operating system they run on.

Although more expensive, hardware firewalls are more commonly used by system administrators managing a corporate network. Hardware firewalls generally have a dedicated processor which runs a small operating system and a variety of applications which help manage network security.

A hardware firewall is shown in FIG. 1. Generally, a firewall 10 stands between an untrusted network 12, such as the public Internet, and a trusted private network 14 such as a secure local area network (LAN). The firewall 10 is stand-alone system that enforces an access control policy between two networks. The actual means by which this is accomplished varies widely, but in principle, the firewall can be thought of as a pair of mechanisms in which one mechanism blocks traffic and the other mechanism permits traffic.

Generally, firewalls are configured to protect against unauthorized logins from an untrusted network. More elaborate firewalls block traffic from the untrusted network, but permit users from the secure LAN to use the untrusted network. Firewalls also provide a single point for important logging and auditing functions generate summaries for the system administrator about what kinds and amount of traffic passed through it and how many attempts where made to break into it.

Types of Firewalls

There are several “species” of firewall and the simplest is a packet filter firewall which operates on specific fields within the IP packet header, such as the source and destination addresses and the protocol type. The packet filter firewall is a standard router equipped with some extra functionality. The extra functionality allows every incoming or outgoing packet to be inspected. Packets meeting some criteria are forwarded normally and those that fail the test are dropped. Packet filters are typically driven by tables configured by the system administrator. These tables list sources and destinations that are acceptable, sources and destinations that are blocked, and default rules about what to do with packets coming from or going to other machines.

In the common case of a UNIX setting, a source or destination address consists of an IP address and a port. Ports indicate which service is desired. For example, port 23 is for Telnet, port 79 is for Finger, and port 119 is for USENET news. Additionally, the packet filter firewall could block incoming packets for all IP addresses combined with one of these ports. In this way, no one outside the trusted network could log in via Telnet, or look up people using the Finger daemon. Furthermore, the trusted network would be spared from having employees spend all day reading USENET news.

One limitation associated with packet filtering is that it is address based, and therefore cannot determine whether a user has been authenticated. Many places on the Internet do not authenticate the source IP address, hence address spoofing is a very real threat. Spoofing is process of gaining entry by submitting a “trusted” IP address to the firewall, thereby gaining entry to the trusted network. Therefore, relying on the source IP address is not a secure solution. Normally, the default action of a packet filter firewall is to either admit or deny a packet when no matching header field is found. There are exceptions to this default action in which packets are selectively denied or admitted by matching a set of header field patterns.

An effective measure against IP spoofing is the use of a protocol such as IPSec. This protocol provides encryption of the data in the packet as well as the source address. A Virtual Private Network (VPN) software or firmware decrypts the packet and the source address and performs a checksum. If either the data or the source address have been tampered with, the packet will be dropped. Without access to the encryption keys, a potential intruder would be unable to penetrate the firewall.

Other firewalls operate at higher protocol layers, and thus can be used only in secure local area networks. They cannot operate in an environment where the IP payload is encrypted. These include a circuit level gateway and an application level gateway.

A circuit level gateway works at the session layer of the OSI model, or the TCP layer of the TCP/IP model. They circuit level gateways monitor TCP handshaking between packets to determine whether a requested session is legitimate Information passed to a remote computer on an untrusted network through a circuit level gateway appears to have originated from the gateway. This is useful for hiding information about private trusted networks. Circuit level gateways are relatively inexpensive and have the advantage of hiding information about the private network they protect. Circuit level gateways do not filter individual packets.

An application level gateway is similar to circuit level gateways except that application level firewalls are application specific. Application firewalls filter data packets at the application layer of the OSI model. Incoming or outgoing data packets cannot access services for which there is no proxy. In plain terms, an application level gateway which may be configured as a web proxy which will not allow any ftp, gopher, telnet or other traffic through. Since they examine data packets at the application layer they can filter application specific commands. This cannot be accomplished with either packet filtering firewalls or circuit level firewalls. Application level gateways can also be used to log user activity. They offer a high level of security, but have a significant impact on network performance. For example, a mail gateway can be set up to examine each message going in or coming out. For each message it makes a decision to transmit or discard the massage based on a header field, message size, or event the content.

Another firewall is referred to as a stateful multilayer inspection firewall. The stateful multilayer inspection firewall combines aspects of the previously described three types of firewalls. They filter packets at the network layer, determine whether session packets are legitimate, and evaluate contents of packets at the application layer. The stateful multilayer inspection firewall allow a direct connection between a client and a host, thereby alleviating the problem caused by the lack of transparency of application level gateways. This firewall relies on algorithms to recognize and process application layer data packets instead of running application specific proxies. Stateful multilayer inspection firewalls offer a high level of security, good performance and transparency to end users. However, they are expensive and are potentially less secure if not administered by highly competent personnel.

Limitations of Firewalls

Due to the expense of hardware type firewalls, hardware firewalls are not traditionally used to prevent unauthorized access to a stand alone devices such as a home computer. The current popularity of broadband applications, which use cable modems and DSL connections, provides an access point for unauthorized access to the stand alone computer. Hardware firewalls for stand alone computers accessing the Internet via a cable modem or DSL connection are known.

However, hardware firewalls which are used by stand-alone computers do not generally provide the level of security that a stateful multilayer inspection firewall provides. Furthermore, hardware firewalls which are used by stand-along computers are not software upgradeable. Additionally, hardware firewalls are unsightly I/O devices which are time-consuming and challenging to configure. Further still, the firewalls for stand alone machines provide only packet filtering capabilities services and are not software upgradeable. As a result, hardware firewalls for stand-alone computers have achieved limited usage. Thus, it would be beneficial to provide a firewall for a stand alone device which is software upgradeable, easily installed and configured, and out of plain view.

With respect to trusted private networks, firewalls can not protect from careless employees or a disgruntled employee. It should not be assumed that the public Internet is the only place where hackers, crackers, thieves and saboteurs may try to attach sensitive information and applications in an enterprise. Sometimes the greatest threat can come from within a secured trusted network itself. Internal security threats include individuals penetrating the physical security of an enterprise to gain access to an internal terminal such as a careless employee hooking up a dial-up line to his or her computer at work, or a disgruntled employee using his access rights to access other networked devices. A traditional firewall does nothing against this type of internal attack. Therefore, it would be beneficial to provide a system and method which can prevent unauthorized access to a networked device from within a trusted network by a careless employee or disgruntled employee.

Additionally, firewalls can not protect against the transmission of viruses from a networked device within the trusted network. In general, a firewall cannot protect against a data-driven attack in which something is mailed or copied to an internal host. From the host within the trusted private an attack by a pest may then be executed. The blocking of viruses at the firewall will only protect against viruses from the Internet. The vast majority of viruses are caught via floppy disks. Therefore, it would be beneficial to provide a system and method which can prevent the dissemination of viruses in a trusted network from a networked device.

### SUMMARY OF INVENTION

1. Advantages of the Invention

One of the advantages of the present invention is that it provides a network access control system which prevents unauthorized access to a host computer from an untrusted network using a cost effective hardware system.

Another advantage of the present invention is that it provides a network access control system which prevents unauthorized access to a host computer from a private trusted network.

A further advantage of the present invention is that it provides a network access control system which prevents unauthorized access to networked devices on a private trusted network from a host computer.

Another advantage of the present invention is that it provides a distributed network access control system which may be configured differently for each networked device.

A further advantage of the present invention is that it provides a network access control system which is housed within the host computer.

A further advantage of the present invention is that it provides a network access control system that is software upgradeable.

Another advantage of the present invention is that it provides a network access control system having its own processor and memory, thereby functioning as a standalone computer.

An additional advantage of the present invention is that it provides a network access control system which has a set of rules that determines various types of authorized activities.

Another advantage of the present invention is that it provides a network access control system that is easily configured and setup.

Yet another advantage of the present invention is that it provides a network access control system that is cost effective to manufacture.

These and other advantages of the present invention may be realized by reference to other portions of the specification, claims, and abstract.

2. Brief Description of the Invention

The invention is a software upgradable network access control system which is preferably resident within a host computer. Preferably, the network access control card is operatively coupled to an expansion card resident within the host computer. In operation, the network access control system controls the flow of data packets to and from a host computer to a network. The host computer may be networked to a network device located on a trusted private network or on an untrusted network. The network access control system includes a dedicated processor, support memory, a first network connection and a second network connection. Preferably, a housing is provided for the network access control system so that it is received by an expansion slot within the host computer. The memory stores an operating system and a set of rules which controls a plurality of data packets which are communicated to and from the network access control system. The data packets communicated to and from the network access control system are controlled by accepting, denying or rejecting data packets. The processor compares received data packets with the set of rules which accept, deny or reject data packets. The first network connection within the housing is configured to enable communications from the processor to the host computer. The second network connection enables communications with a networked device operating in the trusted private network or the untrusted network. Each network access control system may be configured with a different set of rules.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a block diagram of trusted network separated from an untrusted network by a well-known firewall.

FIG. 2 is substantially a block diagram of a network access control system in communication with an untrusted network.

FIG. 3 is substantially a block diagram of a network access control system in communication with a trusted private network and a untrusted network.

FIG. 4 is substantially a block diagram of a network access control system embodied in an expansion card.

FIG. 5 is substantially a method for controlling data packets received by a network access control system.

FIG. 6A is substantially a block diagram of a trusted network having a plurality of network access control systems.

FIG. 6B is substantially a block diagram of an alternative trusted network having a plurality of network access control systems.

### DESCRIPTION OF THE PREFERRED EMBODIMENT

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

Network Access Control System

The network access control (NAC) system described herein is a stand-alone computer, preferably housed within a host computer, that restricts network access from other networked devices to the host computer or restricts network access from the host computer to other networked devices. Preferably, the NAC system is implanted into a personal computer as an expansion card which fits into a PC expansion slot such as a PCI slot. In the alternative the NAC system may be installed directly into a computer system like a USB or FireWire port, or may be housed outside the host computer. The NAC system may operate within a virtual private network. Preferably, the NAC system is installed into each networked device within a private network and is software upgradeable.

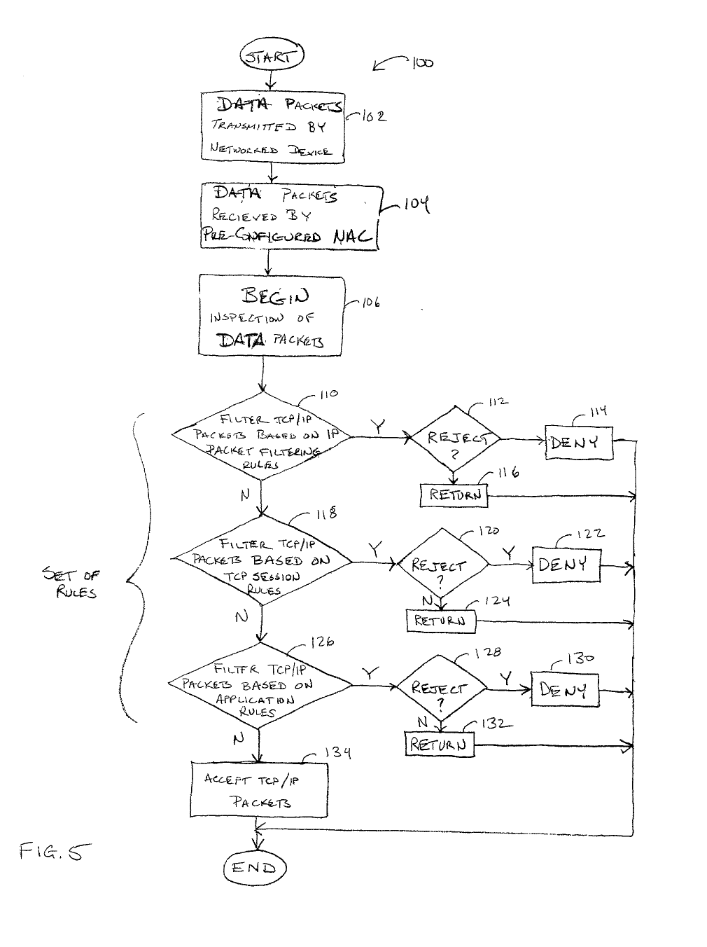

Referring to FIG. 2, there is shown a NAC system 20 which controls the flow of a plurality of data packets communicated between a host personal computer (PC) 22 and an untrusted network 24 such as the Internet. Preferably, the NAC system 20 is housed within the host PC 22 and is referred to as a host PC system 25. The NAC system 20 is in communication with the untrusted network 24 by way of a communications channel 26. Preferably, the NAC system 20 is operatively coupled to the host PC 22 via a host bus (not shown) within the host computer 22. In this configuration, the NAC system 20 receives its power from the host bus of the host PC 22. The NAC system 20 has its own operating system, processor, memory support, and various communication's ports as described in further detail in FIG. 4.

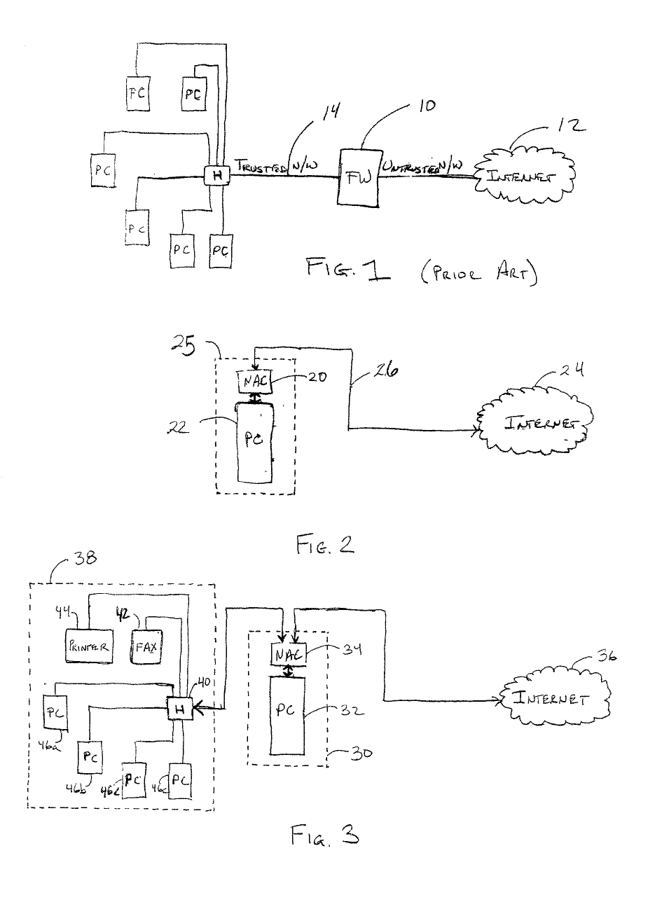

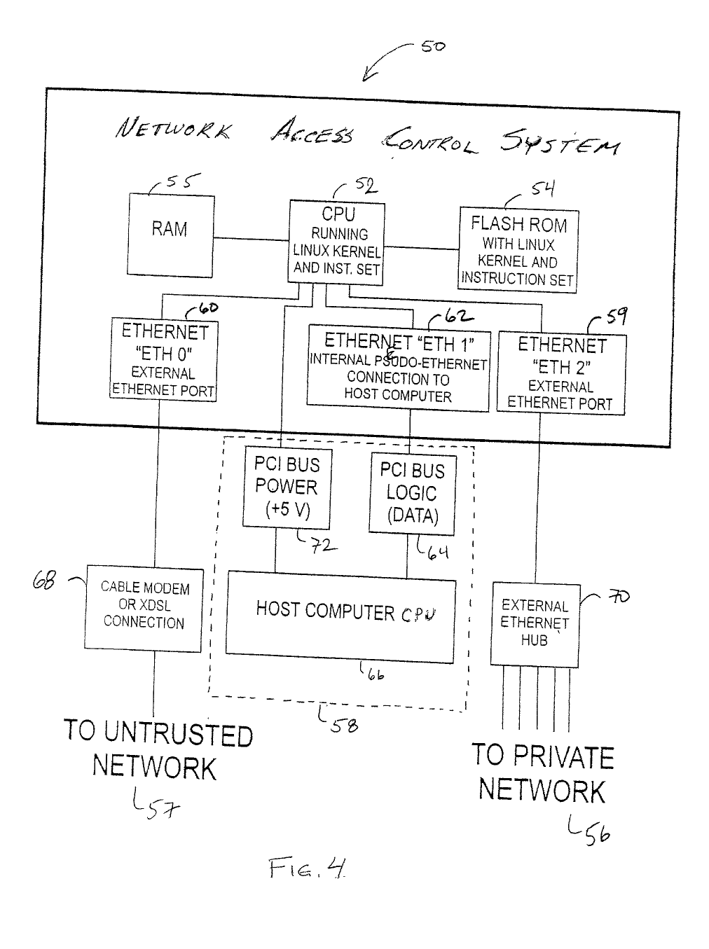

Referring to FIG. 3, there is shown a NAC system which controls the flow of a plurality of data packets communicated between a host computer, a trusted private network and an untrusted private network. More particularly, there is shown a host PC system 30 having a host computer 32 and a NAC 34 which communicates with the Internet 36 and a trusted private network 38 having a hub 40 and a plurality of networked devices. The plurality of networked devices include an enterprise fax machine 42, a printer 44, and a plurality of personal computers 46a, 46b, 46c and 46d. The NAC system 34 operates in a similar manner to the firewall 10 in FIG. 1.

The NAC system 34 is distinguishable from a traditional hardware firewall in that it is substantially more cost effective and is housed within a host computer 32, so the host computer may be used for standard PC tasks rather than operate as a dedicated firewall.

The NAC systems 20 and 34 are both setup and configured remotely either through their respective host computer 22 or 32, or through a computer in the trusted network 38. In either instance, the NAC system 20 appears as a stand alone computer to the either the host computer 22 or the private trusted network 38.

Referring to FIG. 4, there is shown a detailed view of a NAC system 50. Preferably, the NAC system 50 is embodied in an expansion card that fits into the expansion slot, e.g. PCI slot, of a host computer. The implementation of the NAC system 50 as an expansion card is the preferred embodiment of the present invention because it reduces manufacturing costs and the expansion slots are well known on conventional motherboards, thereby making it simple to install the present invention in the host computer. By way of example, the NAC system 50 may fit into a motherboard having an ATX form factor. However, proprietary motherboards may also be configured to include a NAC system 50 within the host computer. Further still, the NAC system 50 may include its own separate housing and may communicate with the host computer via a standard network connection such as an Ethernet connection.

The NAC system 50 is a stand-alone machine which includes a CPU 52, a Flash ROM 54, and a RAM 55. The Flash ROM 54 includes a kernel, an operating system, an instruction set, a plurality of support programs, and a plurality of set of rules. In the preferred embodiment, a cost effective robust operating system such as a Linux based operating system is used. The plurality of set of rules stored in the Flash ROM 54 and processed by the CPU 52 prevents unauthorized activity by accepting, denying or rejecting data packets received by the NAC system 50. The acceptance of data packets permits the packets to proceed to their destination address. The denial of packets drops the packets entirely. The rejection of packets sends the rejected packets back to where they originated and provides information about the basis for rejection.

As described above, the CPU, supporting memory and software provide the limited function of controlling the transfer of data packets across the NAC system 50. As an illustrative example the CPU for NAC system 50 may include an Intel 486 processor, the Flash ROM 54 may be 128 MB in size, and the RAM 55 may be 64 MB in size. The NAC system 50 hardware and use of the Linux operating system in combination with supporting programs resident within a host computer provides a very cost effective alternative to the traditional firewall of FIG. 1. It shall be appreciated by those skilled in the art having the benefit of this disclosure that the combination CPU, ROM and RAM provide the necessary elements for the NAC system 50 to operate as a hardware firewall within the host computer 58.

Additionally, the NAC system 50 also includes network connections to a trusted network 56, an untrusted network 57, and a host computer 58. Preferably, the network connection to the trusted private network is accomplished with an Ethernet port 59, and the network connection to the untrusted network is provided by Ethernet port 60. Preferably, the network connection to the host computer 58 is accomplished by a “virtual” network connection 62 to the host computer bus 64. This virtual network connection 62 appears to the host computer 58 as a simple Ethernet card connection. The virtual network connection 62 is also referred to as a pseudo-Ethernet connection. The virtual network connection 62 to the host computer is implemented using software and thereby avoids the need for two additional NICs, i.e. one on the host computer and another on the NAC system 50. Alternatively, the virtual network connection 62 may be implemented using two additional NICs, however, this solution fails to minimize manufacturing costs. In either case, communications from the CPU 52 are communicated to the host computer CPU 66 via the network connection 62.

For illustrative purposes the NAC system 50 uses a cable modem 68 or DSL connection 68 to achieve communications with the untrusted network 57 via Ethernet port 60. It is well known that cable modem connections and DSL connections which are directly connected to the Internet are generally continuously on and have little or no protection from the untrusted network. Other type of connections may also be made to an untrusted network such as through an ISDN connection, a Ti connection or other such connection. In operation, the NAC system 50 restricts network access by controlling the flow of a plurality of data packets which are communicated between other networked devices in the untrusted network 57 to the host computer 58 and to the private network 56. Additionally, the NAC system 50 may be used to control the flow of data packets between a plurality of networked devices in the private network 56 as described in further detail below.

The NAC system 50 may also be configured to be operatively coupled to a private network 56 by way of an external Ethernet hub 70. It shall be appreciated by those skilled in the art that the use of an Ethernet hub is not required and the reference to the Ethernet hub 70 is provided as an illustrative example. Alternatively, a token ring network system (not shown) may be used to connect the NAC system 50 to the private trusted network 56. During the operation of the NAC system 50, the preferred expansion card embodiment draws its power from the host computer through the host computer bus 72. This preferred embodiment avoids the need to install a separate power supply into the NAC system 50 thereby saving additional manufacturing costs.

Further still, the NAC system 50 may include a plurality of connections (not shown) to networked devices on the private network. By way of example and not of limitation, the NAC system 50 may include a plurality of Ethernet ports which may be operatively coupled to a plurality of networked devices thereby avoiding the need for the external hub 70.

The NAC system 50 is configured using the I/O devices, e.g. keyboard, mouse and monitor, of the host computer 58 or by a networked device in the private network 56. Preferably a web browser (not shown) is used to configure the NAC system 50. Again, the purpose of using the I/O resources of the host computer reduce the manufacturing costs for the NAC system 50. The type of network access controls available by the NAC system 50 are described in further detail below.

NAC System Controls

The network access controls provided by the NAC system 50 operates in conjunction with a virtual private network (VPN). A VPN is a network that shares resources with other VPNs but provides privacy. Privacy refers to confidentiality and integrity as well as separation of capacity. Several methods are available for implementing VPNs such as circuit switching, connection oriented packet switching, and connection IP network infrastructure.

Preferably, the NAC system 50 operates using TCP/IP protocols. The Internet Protocol (IP) is a network layer protocol which is connectionless. A connectionless protocol does not require a connection prior to the communication of data, rather each component of the communication is handled separately by the network. More particularly, the IP protocol provides addressing, routing security, fragmentation and reassembly, and support for quality of service in the packet header. The transmission control protocol (TCP) is a transport-layer protocol that provides a reliable session oriented establishment of logical host-to-host connections over an IP network. TCP implements an efficient packet acknowledgment system that assures application of an error-free properly ordered byte stream. Many of the popular application layer protocols such as HTTP, Telnet and FTP run over TCP.

It shall be appreciated by those skilled in the art having the benefit of this disclosure that the present invention is not restricted by the use of TCP/IP protocols or the connection less network. The NAC system 50 restricts network access from any networked devices which communicates with the host computer 58.

Referring again to FIG. 4, the preferred embodiment of the NAC system 50 functioning as a TCP/IP network access device which connects the private trusted TCP/IP network 56 or the host computer 58 to the external untrusted TCP/IP network 57. In operation, information from either the external untrusted network or the private trusted network or the host computer is examined by the NAC system 50 before being passed to either the host computer, the private trusted network or the untrusted network. All translations and conversion completed by the NAC system 50 are transparent to the end user.

The primary function of the NAC system 50 is to control network access between the host computer, the trusted private network, and the untrusted network. Preferably, network access control is performed by a stateful multilayer inspection firewall. The stateful multilayer inspection firewall filters packets at the network layer, determines whether session packets are legitimate and evaluates contents of packets at the application layer. The stateful firewall relies on algorithms to recognize and process application layer data instead of running application specific proxies.

Preferably, the NAC system 50 stateful inspection firewall is enabled for all data packets which cross the NAC system 50. For the NAC system 50 this includes: data packets generated from the untrusted network 57 and submitted to the host computer 58 or to the private network 56; data packets generated by the host computer 58 and submitted to the untrusted network 57 or to the private network 56; and data packets generated by a networked device within the private network 56 which are submitted to the host computer 58 or to the untrusted network 57.

It shall be appreciated by those skilled in the art that a firewall is used to protect a trusted private network system from an untrusted network system. However, firewalls for trusted private network systems are NOT known. As previously mentioned, a traditional firewall does not protect from internal attacks. However, the present NAC system 50 may be used to protect from internal attacks by controlling host computer access rights.

A secondary function of the NAC system 50 is to provide virus protection from either the untrusted network system 57, the trusted network system 56 or the host computer 58. Presently, many viruses are communicated as attachments to e-mail. The present invention provides a platform which can intercept all e-mails and determining whether they carry viruses by inspecting data packets at the application layer. If it is determined that the e-mails do carry a virus then the e-mail is rejected and is not communicated to either the trusted network 56, the untrusted network 57 or the host computer 58.

Additional functions provided by the NAC system 50 includes taking the private class IP network addresses used in private network 56 and translating these private class addresses into a single address for transmission on the untrusted network 57. Another function includes automatically rejecting private connections to the untrusted network 57 based on the set of rules which prevents unauthorized activity by accepting, denying or rejecting data packets received by the NAC system 50. Finally, the NAC system 50 provides a hardware platform which is software upgradeable so that additional functions may be programmed into the NAC system 50, thereby permitting additional services and upgrades to be readily available to the NAC system 50.

Packet Control Across NAC System

Referring to FIG. 5 as well as FIG. 4, there is shown a method 100 for controlling the plurality of data packets with NAC system 50, thereby preventing unauthorized access between the host computer and a networked device. A networked device includes personal computers, printers, fax machines and other such devices which are operatively coupled to a network. The networked device may operate in either the trusted private network 56 environment or on the untrusted network environment 57.

The method 100 for controlling the plurality of packets received by the NAC system 50 comprises having the network connection 59 in operative communication with the private network 56, having the network connection 60 in operative communication with the untrusted network 57 and having the virtual connection 62 to the host computer. Additionally, the method for controlling the plurality of data packets engages the NAC system 50 includes a processor 52 and support memory operatively coupled to network connection 59 and 60, and virtual connection 62.

With the NAC system 50 in place, the method is engaged at block 100 when a plurality of data packet such as TCP/IP packets are communicated to the NAC system 50. The plurality of data packets may originate from a networked device in the untrusted network, or in the trusted private network or the host computer. Prior to receiving the plurality of data packets, the NAC system 50 is set-up and configured to inspect the plurality of data packets according to a set of rules. The method then proceeds to block 104.

At block 104 the NAC system 50 receives the plurality of data packets via its physical connection 59 or physical connection 60 or virtual connection 62. Preferably, the NAC system 50 is housed within the host computer. The NAC system 50 includes a processor 52 and ROM 54. The ROM 54 is configured with the set of rules which determine whether the plurality of data packets are accepted, rejected or denied. The set of rules prevent unauthorized activity from the plurality of data packets. When the NAC system receives the plurality of data packets, the plurality of data packets are communicated to the CPU 52 for inspection.

At block 106 the processor of the NAC system 50 begins an inspection of the data packets to determine if the data packets should be accepted, rejected or denied. Preferably, the inspection of the data packets is a stateful inspection. However, it shall be appreciated by those skilled in the art that the inspection performed by the processor may be packet based, or session based, or application based, or any combination thereof. The method then proceeds to decision diamond 110.

From diamond 110 to block 134 the various set or rules for the inspection of the plurality of data packets is described. The set of rules includes a plurality of rules that prevent unauthorized activity by accepting, denying or rejection data packets. The set of rules may be configured by a person operating the host computer 58 or by a individual on a networked device on a private trusted network 56. Preferably, the set of rules are configured with a web browser. The set of rules which prevent unauthorized access are compared to each of the data packet received by the processor. Depending on the results of the comparison the data packet is accepted, rejected or denied.

At diamond 110, it is determined whether to filter out the plurality of TCP/IP data packets based on IP packet filtering rules. At diamond 110 every incoming or outgoing TCP/IP data packet is inspected. Packets meeting the IP packet filtering rules are forwarded normally and those that fail the test are dropped. The IP packet filtering rules are typically driven by tables configured by the system administrator. These tables list sources and destinations that are acceptable, sources and destinations that are blocked, and default rules about what to do with packets coming from or going to other networked devices. The IP packet filter rules may be set-up statically or may be set up using the Dynamic Host Configuration Protocol (DHCP). DHCP is a protocol that allows end-system computers to automatically obtain an IP host address, subnet mask and DNS information.

If it is determined that packet does NOT meet the IP packet filtering rules, the TCP/IP packet proceeds to decision diamond 112. At decision diamond 112 it is determined whether to reject the data packet or not reject the data packet. If it is determined to NOT reject the data packet, then the method proceeds to block 114 where the data packet is denied and the packet is dropped entirely. If it is determined to reject the data packet, then the method proceeds to block 116 where the rejected data packet is sent back to where it originated and the data packet is provided information about the basis for rejection.

If it is determined that the data packet does meet the IP packet filtering rules, the method preferably proceeds to decision diamond 118. However, it shall be appreciated by those skilled in the art that satisfactory network access control may be provided by the operations related to decision diamond 112, therefore, additional filtering steps may not be necessary.

At decision diamond 118 it is determined whether to filter out TCP/IP packets based on TCP session rules which monitor TCP handshaking between packets to determine whether a requested session is legitimate. By way of example arid not of limitation, TCP/IP packets are filtered based on specified session rules, such as when a session is initiated by a recognized computer.

If it is determined that the data packets do NOT meet the TCP session rules, then the TCP/IP packets proceeds to decision diamond 120 where it is determined whether to reject the data packet or not. If it is determined to NOT reject the data packet, then data packet is denied and dropped entirely as shown in block 122. If it is determined to reject the data packet, then the packet moves to block 124 where it is sent back to its place of origin and the basis for rejection is provided.

If it is determined that the data packets do meet the TCP session rules, the method preferably proceeds to decision diamond 126. As previously noted, satisfactory control and inspection of the plurality of data packets may be provided solely by the TCP session rules or the IP packet filtering rules. However, in its preferred embodiment a stateful inspection is performed at the network layer, the transport layer and the applications layer.

At decision diamond 126, it is determined whether to filter out the data packets based on application rules which examine packets at the application layer and can thereby filter application specific commands. Additionally, application rules may be used to monitor and log user activity. In one particular application the application rules may be set-up to examine each e-mail message and decide to discard the message based on a determination that the attachment includes a virus as previously described.

If it is determined that the TCP/IP packets do NOT meet the application rules, then the TCP/IP packets proceeds to decision diamond 128 where it is determined whether to reject the data packet or not. If it is determined to NOT reject the data packet, then the data packet is denied and dropped entirely as shown in block 130. If it is determined to reject the data packet, then the packet moves to block 132 where it is sent back to its place of origin and the basis for rejection is provided.

If it is determined that the data packets do meet the application rules, the method preferably proceeds to block 134. As previously noted, satisfactory network access control may be provided solely by either the application rules, the TCP session rules or the IP packet filtering rules. However, in its preferred embodiment network access is controlled by a stateful inspection which includes using packet filtering rules, TCP session rules, and application rules.

At block 134 the determination to accept the data packets is made by the NAC system 50 and the data packet is communicated to its destination address. The destination address includes either a networked device on the untrusted network, or a networked device on the private network, or the host computer. Additionally, the accepted data packet may be translated into a private class address and routed to the untrusted network or other networked device within the private trusted network.

Operation of the NAC System in a Network

Referring back to FIG. 2 and FIG. 3, the NAC system 50 may be used in an environment which interfaces with an untrusted network like the Internet. Due to the lowered manufacturing costs, the NAC system 50 provides a cost effective hardware firewall that is software upgradeable. The NAC system maintains a low manufacturing cost basis due to its reliance on cost effective components such as cost effective processors, maintaining a small profile that fits on an expansion card, using a cost effective operating system, not requiring a power supply by drawing power from the host computer, using the I/O devices of the host computer for to configure the NAC system, and using standard ports to connection with other networked devices. For data packets which are communicated between the host computer and the untrusted network, the NAC system 50 provides a stand-alone hardware system that prevents unauthorized activity with the host computer or the private trusted network as described above.

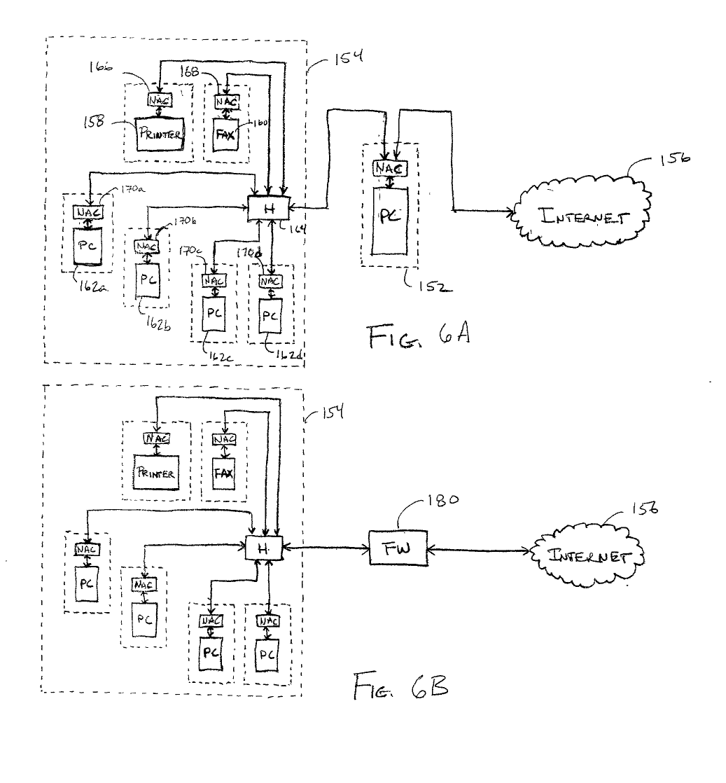

Refeffing to FIG. 6A and 6B, the NAC system 50 may be used in a private network having a plurality of NAC systems cards operatively coupled to each networked device in the private network. As previously mentioned, the NAC system 50 is a small computer that sits within the housing of the host computer and draws its power from the host power supply. Alternatively, the NAC system 50 is used within a trusted network to prevent careless employees or disgruntled employees from disseminating sensitive information or from acting as security threats to an organization. A firewall does nothing against this type of internal attack. However, with a NAC system 50 operatively coupled to each networked device within a private network, a system administrator can restrict the dissemination of sensitive information or minimize potential security threats.

Referring to FIG. 6A there is shown a trusted network having a plurality of NAC systems coupled to the networked devices. The first NAC system 152 acts a conventional firewall and protects the trusted network 154 from the untrusted network 156. The benefit of the NAC system 152 is that permits the host computer to be used to run general computing applications. Additionally, the NAC system 152 may be configured to operate in a different manner from the plurality of NAC systems in the trusted network 154. By way of example, the NAC system 152 may provide only packet filtering and session filtering, thereby allowing for an efficient transfer of data from the untrusted network 156 to the trusted network 154. Each of the plurality of NAC systems within the trusted network 154 may then be configured to provide application layer filtering.

The private network 154 comprises a plurality of networked devices which include a printer 158, a fax machine 160, and a plurality of personal computers, 162a, 162b, 162c and 162d. A hub 164 is used to provide a physical means for allowing communications between the plurality of networked devices. Each of the networked devices is operatively coupled to a NAC system. More particularly, the printer 158 is operatively coupled to NAC 166, the fax machine 160 is operatively coupled to the NAC 168, and the personal computers 162a, 162b, 162c and 162 are operatively coupled to NAC 170a, 170b, 170c and 170d, respectively.

For the system described in FIG. 6A, host access control rights may be programmed into each NAC 170a through 170d, thereby restricting access between each of the networked devices in the private network 154. Host access control rights prevent access to other networked devices based on the location of the computer. By way of example and not of limitation, a system administrator's host computer may have access to the resources of other networked devices, however, other networked devices may NOT have access to the system administrator's host computer. In an alternative example, personal computer 162a on the private network 154 may have authorization to print sensitive information on printer 158. However, personal computer 162d may not have authorization to print sensitive information.

FIG. 6A and FIG. 5 also provides a diagram of a distributed network access control system and method, i.e. a distributed firewall. The distributed firewall permits the operation of a firewall to be distributed throughout the private network. As previously noted, a firewall generally operates at the network, transport application layer, or any combination thereof of the TCP/IP model. The present invention provides a system and method wherein NAC at host computer 152 may, as an illustrative example, provide packet filtering and perform as a circuit level gateway. Each of the NACs in the private network 154 may then be used as application level gateways. Additionally, different types of firewalls may be combined to operate with the plurality of NAC systems as shown in FIG. 6B.

Referring to FIG. 6B there is shown a block diagram of an alternative private network using a dedicated firewall 180 to provide access to the private network 154. In this alternative embodiment the dedicated firewall may function as one of the firewalls described in the prior art section of this specification. Each of the plurality of NACs may operate to either provide additional levels of security for the networked devices in the private network 154 or for the distributed network access control system.

As a further illustrative example, private network 154 having a first computer 162a and a second computer 162b are operatively coupled to NAC systems 170a and 17b, respectively. Each NAC system 170a and 170b inspects the plurality of data packets received by each respective NAC system according to a first set of rules associated with NAC system 170a and a second set of rules associated with NAC system 170b. The first set of rules are different from the second set of rules, thereby providing the first computer 162a with a different level of authorization than the second computer 162b.

### CONCLUSION

It can now be seen that the present invention solves many of the problems associated with the prior art firewalls. The present invention provides a network access control system and method which is preferably housed within a host computer and is configured to control a plurality of data packets. The present invention operates within a private networked environment or an untrusted networked environment or any combination thereof.

Although the description above contains many specifications, these should not be construed as limiting the scope of the invention but as merely providing illustrations of some of the presently preferred embodiments of this invention. The specification, for instance, makes reference to bonus prizes. However, the present invention is not intended to be limited to bonus prizes. Rather it is intended that the present invention can be used independently as a stand-alone game. Thus, the scope of the invention should be determined by the appended claims and their legal equivalents rather than by the examples given.

What is claimed is:

1. A network access control system configured to control the transfer of a plurality of data packets between a private networked device and a host computer, comprising:
a housing configured to be received by a host computer;
a first memory within said housing, said first memory configured to store an network access operating system and a set of rules, said set of rules configured to prevent unauthorized activity between said private networked device and said host computer;
a processor within said housing and in communication with said first memory, said processor configured to process said network access operating system and said set of rules;
a first network connection operatively coupled to said processor, said first network connection configured to communicate a plurality of first connection data packets to said host computer subject to said set of rules; and
a second network connection operatively coupled to said processor, said second network connection configured to communicate a plurality of second connection data packets to said private networked device subject to said set of rules.

2. The network access control system of claim 1 wherein said set of rules filter out said plurality of first connection data packets based on packet filtering rules.

3. The network access control system of claim 1 wherein said set of rules filter out said plurality of first connection data packets based on TCP session rules.

4. The network access control system of claim 1 wherein said set of rules filter out said plurality of first connection data packets based on application rules.

5. The network access control system of claim 1 wherein said set of rules are configured by said private networked device.

6. The network access control system of claim 1 further comprising a third network connection operatively coupled to an untrusted network, said third network configured to communicate a plurality of third connection data packets to said untrusted network subject to said set of rules.

7. The network access control system of claim 1 operatively coupled to a host bus within said host computer, said network access control system configured to draw power from said host bus.

8. A network access control system configured to control communications between a host computer and a networked device within a private network and a networked device within an untrusted network, comprising:
a housing configured to be received by an expansion slot within said host computer;
a first memory within said housing, said first memory configured to store an operating system and a set of rules, said set of rules configured to control the transfer of a plurality of data packets between said host computer and said networked device;
a processor within said housing and in communication with said first memory, said processor configured to process said operating system and said set of rules;
a first network connection within said housing, said first network connection configured to communicate said plurality data packets between said network access control system and said host computer; and
a second network connection within said housing, said second network connection configured to communicate said plurality of data packets between said network access control system and said networked device within said private network; and
a third network connection within said housing, said third network connection configured to communicate said plurality of data packets between said network access control system and said untrusted network.

9. The network access control system of claim 8 wherein said set of rules filter said plurality of data packets based on packet filtering rules.

10. The network access control system of claim 8 wherein said set of rules filter said plurality of data packets based on TCP session rules.

11. The network access control system of claim 8 wherein said set of rules filter said plurality of data packets based on application rules.

12. A private network system, comprising
a first host computer;
a first network access control system operatively coupled between said first host computer and said private network system, said network access control system configured to control a plurality of data packets communicated across said first network access control system;
a second host computer; and
a second network access control system operatively coupled between said second host computer and said private network system, said network access control system configured to control a plurality of data packets communicated across said second network access control system.

13. The private network system of claim 12 wherein said first network access control system comprises a first network access control memory, said first network access control memory configured to store a first network access control system set of rules, said first network access control system set of rules configured to prevent unauthorized activity between said first host computer and said private network system.

14. The private network system of claim 13 wherein said second network access control system comprises a second network access control memory, said second network access control memory configured to store a second network access control system set of rules, said second network access control system set of rules configured to prevent unauthorized activity between said second host computer and said private network system.

15. A method for preventing unauthorized access between a host computer and a networked device within a private network, comprising:
providing a network access control system having a first network connection to said host computer and a second network connection to said networked device;
housing said network access control system within said host computer;
configuring said network access control system with a first set of rules, said first set of rules configured to prevent unauthorized activity between said host computer and said networked device;
receiving a plurality of data packets into said network access control system;
inspecting said plurality of data packets with said first set of rules at said network access control system; and
communicating said plurality of data packets according to the results of said inspecting of said plurality of data packets.

16. The method of claim 15 further comprising configuring said network access control system with a networked computer within said private network.

17. The method of claim 15 further comprising filtering out data packets based on packet filtering rules

18. The method of claim 15 further comprising filtering out data packets based on TCP session rules.

19. The method of claim 15 further comprising filtering out data packets based on application rules.

20. The method of claim 15 further comprising accepting said plurality of data packets according to acceptable results from said inspecting of said plurality of data packets.
